(19) United States
(12) Patent Application Publication
(10) Pub. No.: US 2010/0256817 A1
(43) Pub. Date: Oct. 7, 2010

(54) Method of adjusting laser beam pitch by controlling movement angles of grid image and stage

(75) Inventors: Jong Su Kim, Bucheon-si (KR); Dong Woo Kim, Gangnam-gu (KR)

Correspondence Address: JORDAN AND HAMBURG LLP, 122 EAST 42ND STREET, SUITE 4000, NEW YORK, NY, 10168, US

(73) Assignee: PROTEC CO., LTD., Namchon-dong (KR)

(21) Appl. No.: 12/460,653

(22) Filed: Jul. 21, 2009

(30) Foreign Application Priority Data
Apr. 6, 2009 (KR) 10-2009-0029334

(51) Int. Cl. G01M 1/38

(52) U.S. Cl. 700/275

(57) ABSTRACT

The present invention relates to a method of adjusting a laser beam pitch by controlling the movement angles of a grid image and a stage, which is intended to solve the conventional problem in that, when exposure is performed after only a stage is moved in a diagonal direction while an exposure mask image is not rotated, an exposed image is distorted into the shape of a parallelogram. In the method, a factor K for repeated patterns is defined based on exposure parameter data. Thereafter, a rotation angle θ is obtained through computational processing. The stage is moved by the obtained rotation angle θ in a diagonal direction. A grid image rotated by the obtained rotation angle θ is generated. Therefore, the pitch between laser beams radiated onto the exposed surface of a board is adjusted through a DMD module, thus realizing high-resolution LER.

### BACKGROUND OF THE INVENTION

1. Field of the Invention

The present invention relates to a method of adjusting a laser beam pitch by controlling the movement angles of a grid image and a stage.

In particular, the present invention relates to a method of adjusting a laser beam pitch by controlling the movement angles of a grid image and a stage, which adjusts a pitch between laser beams radiated onto the exposed surface of a board (PCB) through a Digital Micromirror Device (DMD) module by rotating a grid image, that is, a mask image, together with a stage supporting the board, thus realizing high-resolution Line Edge Roughness (LER).

2. Description of the Related Art

As the Printed Circuit Board (PCB) industry has entered a turning point at which fields including existing hard PCBs have extended to various fields including flexible PCBs to satisfy the improved performance of various digital devices, a great improvement in performance of PCBs has been required. In order to actively comply with the requirement of such a great improvement in performance of PCBs, a new type of exposure system capable of realizing a hyperfine circuit line width on a PCB is required.

Further, this requirement results in requiring the application of new technology that not only can flexibly cope with small production and mass production systems for producing various types of products, but also can realize the remarkable reduction of an exposure process and improvement in productivity, in addition to providing for innovations of technology for the implementation of an exposure system from low resolution to high resolution. As a result, various exposure methods have been developed, and, for example, a maskless direct imaging exposure method based on Laser Direct Imaging (LDI), is one of those methods.

The problem of a conventional mask exposure system lies in the fact that it is difficult to perform high-resolution exposure due to an increase in mask production costs and management costs when a high-resolution micro-circuit pattern is exposed. In order to solve the problem of the conventional mask exposure system, maskless processing technologies for realizing the high resolution required for the implementation of hyperfine circuit line width and reducing the number of processes have recently been focused on.

In order to comply with maskless processing technologies, an exposure system provided with a Digital Micromirror Device (DMD) has been developed. Such an exposure system uses a principle by which a plurality of micromirrors transmits some of the beams, incident thereon at a predetermined angle, at a desired angle, and transmits the remaining beams at another angle, and thus a single screen is created using only necessary beams.

In the above-described exposure system, beams emitted from a UV light source and on/off modulated by a DMD module have rectangular shapes which are the shapes of respective micromirrors constituting the DMD module. Because of this, when the image of a pattern is implemented, rectangular beams are roughly processed due to the characteristics of the rectangular shapes.

Therefore, a mask or the like is disposed between a first projection lens system and a second projection lens system and configured to change rectangular beams into circular beams and radiate the circular beams, thus assisting the edge of a pattern to be more softly processed when the image of the pattern is implemented.

Further, in the prior art, in order to implement high-resolution Line Edge Roughness (LER) by adjusting the pitch between laser beams radiated onto the exposed surface of a board on a stage, exposure is performed by moving only the stage in a diagonal direction while an exposure mask image, that is, a grid image, is not rotated. However, in this case, there is a problem in that the shape of an exposed image is distorted into the shape of a parallelogram, so that the original image is exposed in a shape different therefrom.

### SUMMARY OF THE INVENTION

Accordingly, the present invention has been made keeping in mind the above problems occurring in the prior art, and an object of the present invention is to realize high-resolution roughness by adjusting the pitch between laser beams radiated onto the exposed surface of a board through a DMD module by rotating a grid image, that is, a mask image, together with a stage supporting the board.

In order to accomplish the above object, the present invention provides a method of adjusting a laser beam pitch by controlling movement angles of a grid image and a stage, the method generating the grid image required to expose a board on the stage by selectively turning on or off a plurality of Digital Micromirror Devices (DMDs) constituting a DMD module through an algorithm, comprising defining a factor K for repeated patterns based on exposure parameter data; obtaining a rotation angle θ through computational processing; moving the stage by the obtained rotation angle θ in a diagonal direction; and generating a grid image rotated by the obtained rotation angle θ.

Preferably, the rotation angle θ may be a rotation angle by which the stage and the grid image are rotated with respect to diagonal lines thereof.

Preferably, the stage and the grid image may be rotated by a same angle θ.

Preferably, the generation of the grid image having the rotation angle θ from a normal grid image may be performed using an algorithm for turning on/off the plurality of DMDs constituting the DMD module.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing a process for performing exposure while moving a stage in the X and Y axis directions;

FIG. 2 is a diagram showing a process for performing exposure while moving a stage, rotated by a certain angle, in the X and Y axis directions;

FIG. 3 is a diagram showing a grid image and an exposed surface, formed by performing exposure while moving only a stage in a diagonal direction by a certain angle;

FIG. 4 is a diagram showing a grid image and an exposed surface, formed by performing exposure while moving a stage in a diagonal direction by a certain angle and rotating a grid image by a certain angle; and

FIG. 5 is a diagram showing the relationship between a DMD module and the rotation angles of a grid image.

### DESCRIPTION OF THE PREFERRED EMBODIMENTS

Hereinafter, embodiments of the present invention will be described in detail with reference to the attached drawings.

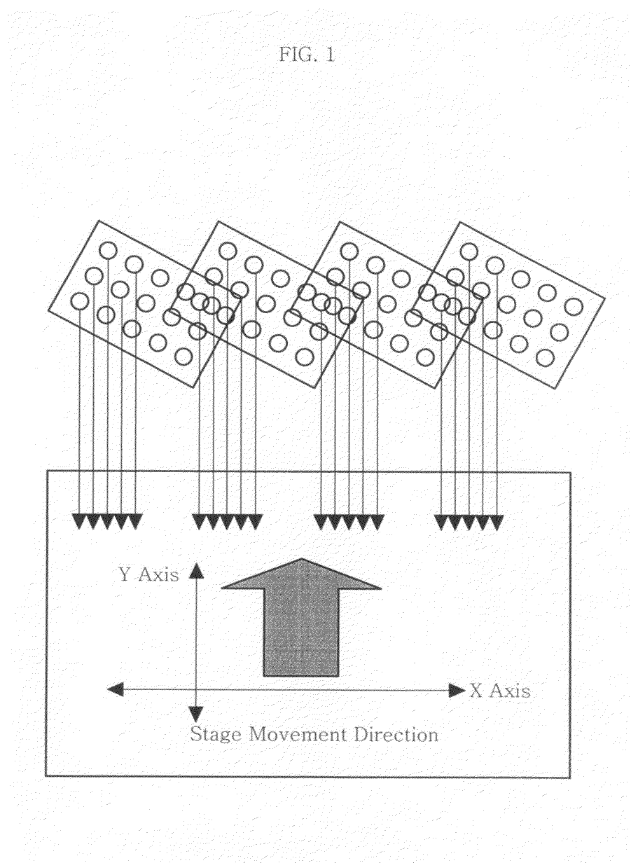

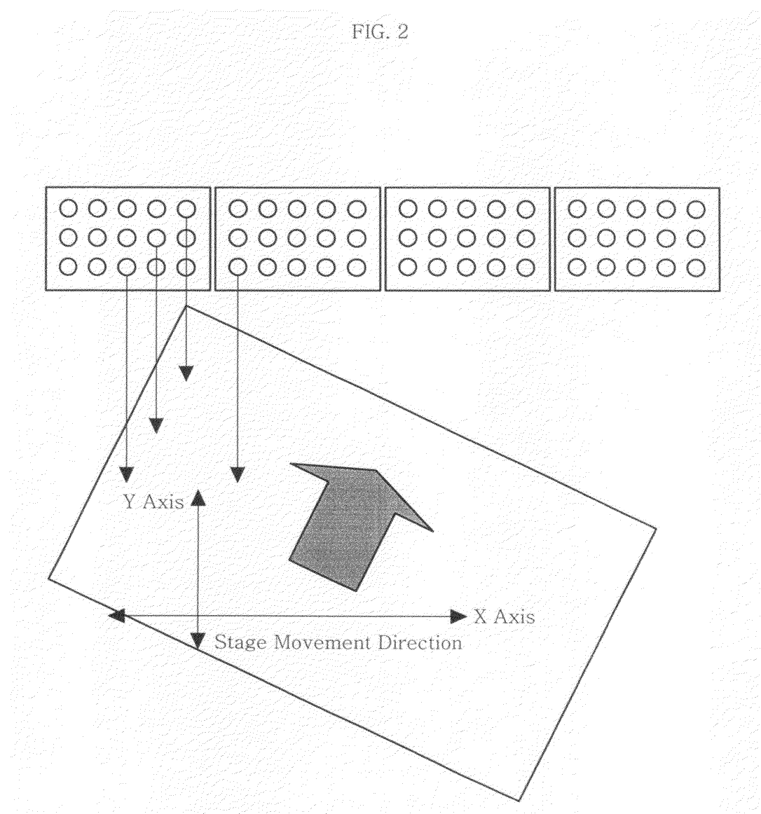

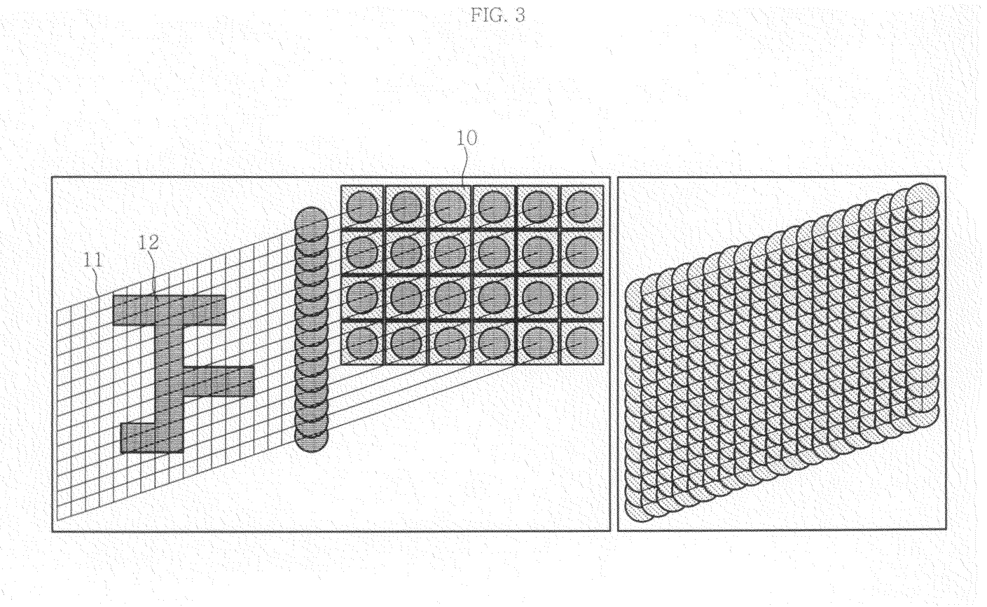

FIG. 1 is a diagram showing a process for performing exposure while moving a stage in the X and Y axis directions, FIG. 2 is a diagram showing a process for performing exposure while moving a stage, rotated by a certain angle, in a diagonal direction by simultaneously moving the stage in the X and Y axis directions, and FIG. 3 is a diagram showing a grid image and an exposed surface, formed by performing exposure while moving only a stage in a diagonal direction by a certain angle;

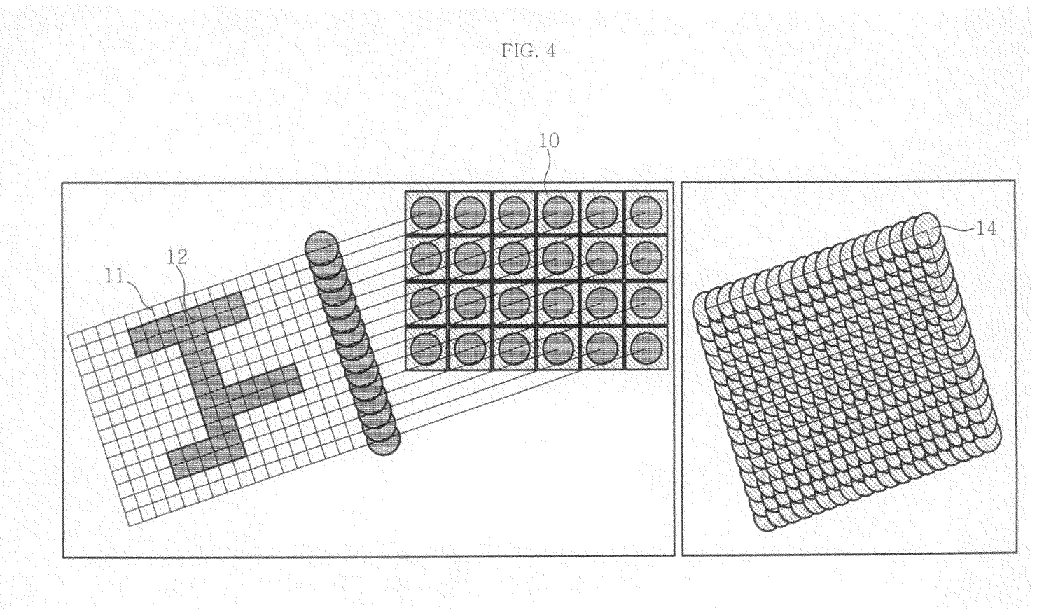

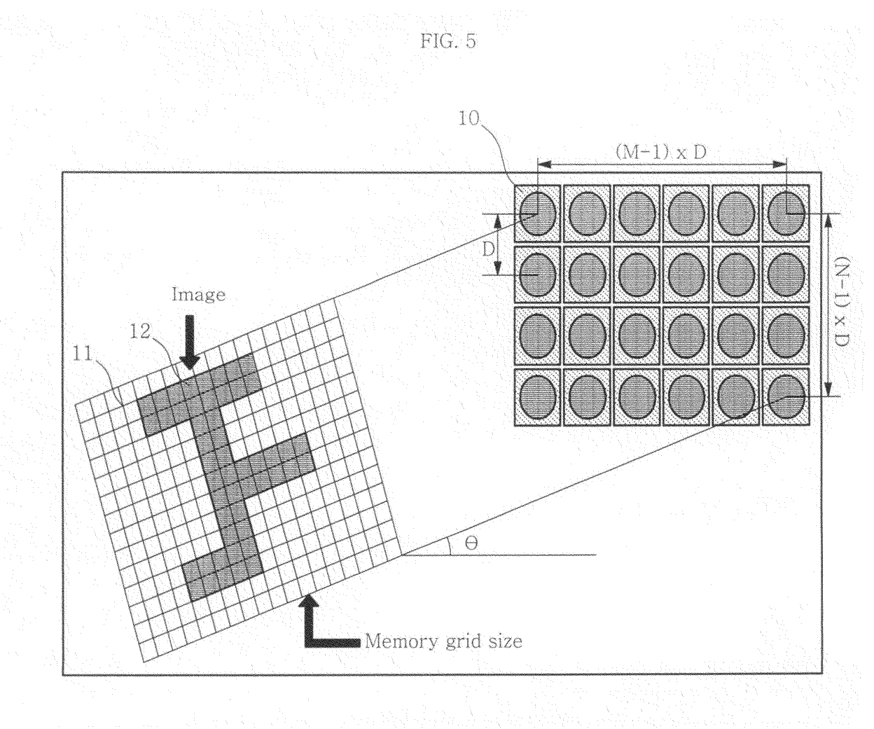

FIG. 4 is a diagram showing a grid image and an exposed surface, formed by performing exposure while moving a stage in a diagonal direction by a certain angle and rotating a grid image by a certain angle, and FIG. 5 is a diagram showing the relationship between a DMD module and the rotation angles of a grid image.

Typically, an exposure system for exposing a board or the like may include a light source, a diffractive optical device, a Fourier transform lens, DMD modules, a mirror, first and second optical lens systems, a beam shift device, a stage, etc.

FIGS. 1 and 2 illustrate a process for exposing a board on a stage while moving the stage in the X and Y axis directions to realize high-resolution Line Edge Roughness (LER) by adjusting the pitch between laser beams radiated onto the exposed surface of the board.

In FIG. 1, exposure is performed in such a way as to radiate laser beams onto the exposed surface of the board on the stage while moving the stage in the X and Y axis directions after the DMD modules are rotated by a certain angle, thus realizing high-resolution LER by adjusting the pitch between the laser beams.

In FIG. 2, exposure is diagonally performed in such a way as to radiate laser beams onto the exposed surface of the board on the stage while simultaneously moving the stage in the X and Y axis directions after the stage has been rotated by a predetermined angle, thus realizing high-resolution LER by adjusting the pitch between the laser beams.

In the case of FIGS. 1 and 2, high-resolution LER is partially implemented by adjusting the pitch between laser beams, but an exposed image is distorted into the shape of a parallelogram, and thus the original image is exposed in a shape different from that of the original image.

That is, as shown in FIG. 3, when the board on the stage is exposed using reflected laser beams through the selective ON/OFF operations of a plurality of DMDs constituting a DMD module 10 under the control of a DMD controller (not shown), the sizes of a grid image 12 and a memory grid 11 are not identical to each other, so that the formation of a pattern is impossible. In addition, when the stage is moved in a diagonal direction, exposure is performed in the shape of a parallelogram.

Unlike this structure, when exposure is performed while the stage 14 is moved in a diagonal direction after the grid image 12 has been rotated by a certain angle θ, without the rotation of the DMD module 10, as shown in FIG. 4, exposure is implemented in the shape of a square in which the sizes of the grid image 12 and the memory grid 11 are identical to each other. Accordingly, the pitch between the laser beams is adjusted, and thus a uniform pattern may be formed while high-resolution LER is realized.

In this case, the DMD module 10 and the stage 14 are driven under the control of a controller, including the DMD controller. The DMD controller defines a factor K for repeated patterns on the basis of exposure parameter data, obtains a rotation angle θ through computational processing, moves the stage 14 in a diagonal direction by the obtained rotation angle θ, and generates the grid image 12 rotated by the rotation angle θ.

In this case, the rotation angle θ denotes a rotation angle by which the stage 10 and the grid image 12 are rotated with respect to the diagonal lines thereof. Of course, it is preferable for the stage 10 and the grid image 12 to have the same angle θ.

The DMD controller generates a grid image having a rotation angle θ from the normal grid image by turning on or off a plurality of DMDs, constituting the DMD module, through the use of an algorithm included in the DMD controller.

FIG. 5 illustrates the relationship between the DMD module 10 and the rotation angle θ of the grid image 12, wherein the rotation angle θ is calculated using the algorithm included in either the DMD controller or a controller including the DMD controller.

That is, the lateral length and vertical length of the DMD module, memory grid size (S, T), scan step distance, and rotation angle θ can be obtained by the following equations when the number of vertical DMDs (M) constituting the DMD module 10 is 4, the number of lateral DMDs (N) is 6, the distance between the respective DMDs is 14 μm, a factor K for repeated patterns is 2, the size of a laser beam is 10 μm, and the size of a DMD, that is, a micromirror, is 13 μm.

First, the lateral length of the DMD module is (M−1)*D.

Therefore, the lateral length of the DMD module is (4−1)*14, that is, 42 μm.

Next, the vertical length of the DMD module is (N−1)*D.

Therefore, the vertical length of the DMD module is (6−1)*14, that is, 70 μm.

Further, the size S of the memory grid is N+(M−1)*M/K, and is then 4+(6−1)*6/2, that is, 19.

Further, the size T of the memory grid is M+(N−1)*M/K, and is then 6+(4−1)*6/2, that is, 15.

Finally, since the scan step distance is 4.427 μm, the rotation angle θ is tan⁻¹(θ)=K/M , so that tan⁻¹(θ)=2/6, that is, 1/3. Thus, the rotation angle θ is 18.435°.

TABLE 1

| | K = 1 | K = 2 | K = 3 | K = 6 |
|---|---|---|---|---|
| Rotation angle (θ) | 9.462 | 18.435 | 26.565 | 45 |
| S | 24 | 15 | 12 | 9 |
| T | 34 | 19 | 14 | 9 |

Table 1 shows the rotation angles θ and memory grid sizes S and T, obtained by the DMD controller when the factors for repeated patterns are 1, 2, 3 and 6, respectively.

Therefore, the present invention is advantageous in that the pitch between laser beams radiated onto the exposed surface of a board through a DMD module is adjusted by rotating a grid image, that is, a mask image, together with a stage supporting the board, thus realizing high-resolution Line Edge Roughness (LER).

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of adjusting a laser beam pitch by controlling movement angles of a grid image and a stage, the method generating the grid image required to expose a board on the stage by selectively turning on or off a plurality of Digital Micromirror Devices (DMDs) constituting a DMD module through an algorithm, comprising:
defining a factor K for repeated patterns based on exposure parameter data;
obtaining a rotation angle θ through computational processing;
moving the stage by the obtained rotation angle θ in a diagonal direction; and
generating a grid image rotated by the obtained rotation angle θ.

2. The method according to claim 1, wherein the rotation angle θ is a rotation angle by which the stage and the grid image are rotated with respect to diagonal lines thereof.

3. The method according to claim 1, wherein the stage and the grid image are rotated by a same angle θ.

4. The method according to claim 1, wherein the generation of the grid image having the rotation angle θ from a normal grid image is performed using an algorithm for turning on/off the plurality of DMDs constituting the DMD module.
